(19) United States
(12) Patent Application Publication
(10) Pub. No.: US 2011/0102283 A1
(43) Pub. Date: May 5, 2011

(54) Integrated Multi-Band Antenna

(75) Inventors: Yao-Yuan Chang, Taipei County (TW); Tsung-Wen Chiu, Taipei (TW); Fu-Ren Hsiao, Taipei (TW); Wen-Shyang Chen, Taipei (TW)

(73) Assignee: ADVANCED-CONNECTEK, INC., Taipei County (TW)

(21) Appl. No.: 12/649,670

(22) Filed: Dec. 30, 2009

(30) Foreign Application Priority Data
Oct. 30, 2009 (TW) 098136944

(51) Int. Cl. H01Q 5/00; H01Q 1/48; H01Q 1/36

(52) U.S. Cl. 343/749; 343/848

(57) ABSTRACT

An integrated multi-band antenna comprises a first conductor, a second conductor, at least one inductor member, an extension conductor, and a grounding plane. The first conductor and a first branch of the second conductor form a first coupling region. The inductor member is arranged near the first branch. The extension conductor is arranged near a second branch of the second conductor and extends therefrom to form a terminal. The terminal and first conductor form a second coupling region. The first and second coupling regions are arranged on opposite sides of the first conductor. The second branch connects to the grounding plane. The present invention adopts a design incorporating the capacitive coupling of the conductors and the choke of the inductor member, integrates the standard frequency bands of the low-frequency and high-frequency systems of the digital TV to achieve a miniaturized digital TV antenna spanning a wide range of frequency bands.

### BACKGROUND OF THE INVENTION

1. Field of the Invention

The present invention relates to an integrated multi-band antenna, particularly to an antenna integrating the standard frequency bands of the high-frequency and low-frequency systems of the digital TV.

2. Description of the Related Art

The digital TV is going to be the indispensable apparatus of the portable wireless communication devices. The government departments, manufacturers, research organizations and universities are all devoted to developing miniature and high-performance antennae to achieve the objective that the users can enjoy high-quality digital TV programs anytime. For effectively receiving electromagnetic waves, an antenna needs to have a length of at least one fourth of the wavelength of the electromagnetic waves. The electromagnetic wavelength of the current digital TV ranges from 30 to 75 cm. The antenna will have a length longer than that of a mobile phone if the antenna is fabricated according to the aforementioned principle.

To make the antenna not only meet the aforementioned principle but also dwell inside the mobile communication device, the conventional technology transforms the linear monopole antenna into a circuitous antenna or spiral antenna. The circuitous antenna usually has an S form, and the adjacent portions thereof have opposite-direction currents, which result in the mutual interference of the electromagnetic signals and cause the inefficiency of receiving the electromagnetic waves. The electronic elements are generally fabricated by a 2D printing method. However, the spiral antenna is a 3D structure. Thus, the spiral antenna would increase the fabrication cost.

Refer to FIG. 1A and FIG. 1B respectively a top view and a bottom view of a U.S. Pat. No. 7,486,237 “Miniaturized Planar Antenna of Digital Television”. This prior art pertains to a planar miniature digital-TV antenna. The antenna 10 comprises an insulating board 11, a metal radiation member 12, a metal grounding member 13 and a metal parasitic member 14. The metal radiation member 12 is arranged on a first surface of the insulating board 11. The metal grounding member 13 and metal parasitic member 14 are arranged on a second surface of the insulating board 11. The metal radiation member 12 has a serpentine portion 121, and the metal parasitic member 14 also has a serpentine portion 141 corresponding to the metal radiation member 12. The metal parasitic member 14 can increase the frequency bands received by the antenna and promote the transmission efficiency of the digital TV signals.

Wireless signal transmission must be implemented by the electric coupling of the serpentine portion 121 of the metal radiation member 12 and the serpentine portion 141 of the metal parasitic member 14. Besides, a thicker second end 143 is also added to the insulating board 11 to increase the area of the radiation conductor. However, such a design results in too large an antenna and impairs the miniaturization of the antenna. Further, the serpentine portions 121 and 141 have too long a length, which results in a complicated signal transmission path and an instable transmission quality. Moreover, the increase of the frequency bands is usually limited although the metal parasitic member 14 is arranged on the second surface of the insulating board 11 to increase the range of the frequency bands.

### SUMMARY OF THE INVENTION

The primary objective of the present invention is to provide an integrated multi-band antenna, which adopts a design incorporating the capacitive coupling of conductors and the choke of an inductor member to form a loop monopole antenna, and which integrates the standard frequency bands of the low-frequency and high-frequency systems of the digital TV, and which achieves a miniaturized digital TV antenna spanning a wide range of frequency bands and having superior transmission capability.

Another objective of the present invention is to provide an integrated multi-band antenna, wherein two coupling regions generates capacitive impedance providing superior impedance matching for the frequency bands of the low-frequency and high-frequency systems, and wherein the inductor member has a serpentine and small-spacing path, and wherein the inductance can be varied to modify the impedance matching of the antenna, whereby the extension path of the radiation conductors is effectively reduced, and whereby the antenna system has wide transmission frequency bands and stable transmission quality.

To achieve the abovementioned objectives, the present invention proposes an integrated multi-band antenna, which comprises a first conductor, a second conductor, at least one inductor member, an extension conductor, and a grounding plane. The first conductor and a first branch of the second conductor form a first coupling region. The inductor member is arranged near the first branch of the second conductor. The extension conductor is arranged near a second branch of the second conductor and extends therefrom to form a terminal. The terminal and the first conductor form a second coupling region. The first coupling region and the second coupling region are respectively arranged on opposite sides of the first conductor. The second branch of the second conductor connects to the grounding plane.

In the present invention, a first coupling region and a second coupling region are respectively arranged on two opposite sides of the first conductor to form two conduction paths of the high-frequency signals. The two conduction paths respectively correspond to the standard frequency bands of the low-frequency and high-frequency systems of the digital TV. As to the standard frequency bands of the low-frequency system, the first conductor and a first branch of the second conductor form a first coupling region, and at least one inductor member is arranged near the first branch of the second conductor, wherein the high-frequency signal from a feeder cable is coupled from the first conductor to the second conductor in the first coupling region, whereby a loop antenna structure is formed to implement the standard frequency bands of the low-frequency system. The inductor member has a serpentine path with small spacings. Via adjusting the spacings, width and length of the inductor member, the inductance can be varied, and the impedance matching of the antenna can thus be modified. In cooperation with the capacitive impedance of the first coupling region, the antenna can have superior impedance matching. Thereby, the antenna of the present invention has wide transmission frequency bands and stable transmission quality.

As to the standard frequency bands of the high-frequency system, the first conductor and the terminal of the extension conductor form a second coupling region; adjusting the capacitance of the second coupling region not only can modify the input impedance of the antenna but also can reduce the size of the antenna; the first conductor, extension conductor and second conductor form a coupled-input monopole antenna structure, which can generates the standard frequency bands of the high-frequency system of the digital TV. Via fine tuning the sizes, lengths and volumes of the extension conductor and the second conductor, the frequency bands of the antenna system can have better impedance matching.

The inductor member is installed on the second conductor. When the feed-in signal of the frequency band of the high-frequency system is conducted from the first conductor, through the extension conductor, to the second conductor, the inductor member functions a signal choke interface to interrupt the transmission of the signal of the frequency band of the high-frequency system lest the signals of the high-frequency and low-frequency systems interfere mutually. The design of the serpentine paths of the two coupling regions and the inductor member can effectively shorten the paths of the radiation conductors and reduce the space occupied by the antenna layout. Therefore, the present invention can widen the frequency bands and miniaturize the antenna size at the same time.

Below, the embodiments are described in detail to make easily understood the technical contents of the present invention.

### BRIEF DESCRIPTION OF THE DRAWINGS

FIG. 1A is a top view of a U.S. Pat. No. 7,486,237 “Miniaturized Planar Antenna of Digital Television”;

FIG. 1B is a bottom view of a U.S. Pat. No. 7,486,237 “Miniaturized Planar Antenna of Digital Television”;

FIG. 2 is a top view schematically showing an integrated multi-band antenna according to a first embodiment of the present invention;

FIG. 3 is a top view schematically showing an integrated multi-band antenna according to a second embodiment of the present invention;

FIG. 4 is a diagram showing the measurement results of the return loss of the antenna system according to the second embodiment of the present invention; and

FIG. 5 is a top view schematically showing that an integrated multi-band antenna according to a third embodiment of the present invention is integrated with a substrate of a digital TV.

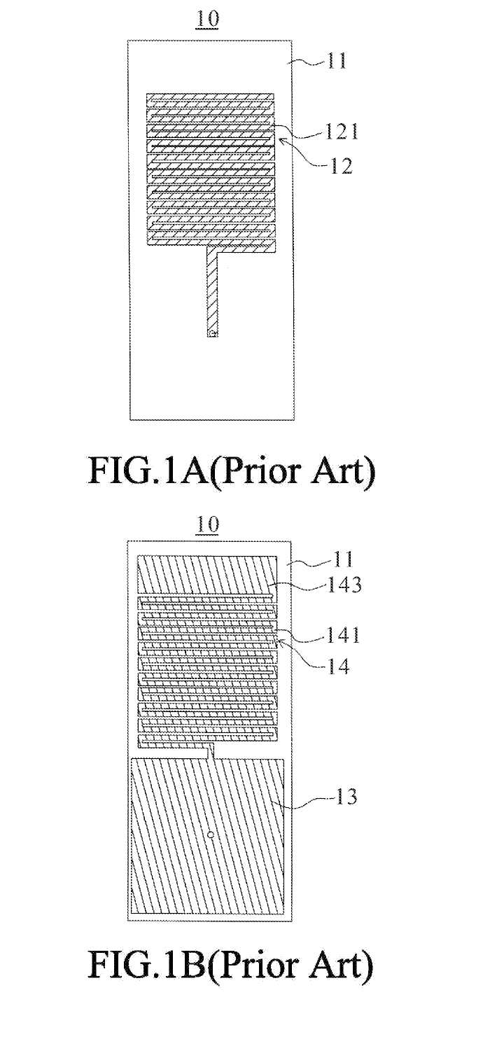

### DETAILED DESCRIPTION OF THE INVENTION

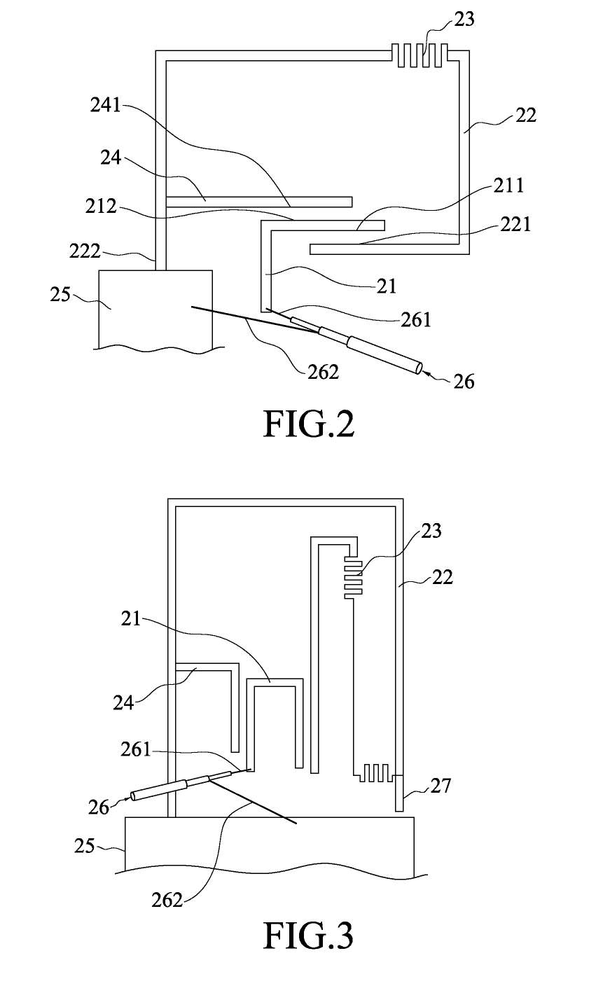

Refer to FIG. 2 a top view schematically showing an integrated multi-band antenna according to a first embodiment of the present invention. The integrated multi-band antenna of the present invention comprises a first conductor 21, a second conductor 22, at least one inductor member 23, an extension conductor 24 and a grounding plane 25.

A first end 211 of the first conductor 21 and a first branch 221 of the second conductor 22 form a first coupling region. The inductor member 23 is arranged near the first branch 221 of the second conductor 22. The extension conductor 24 is a straight-line structure arranged near a second branch 222 of the second conductor 22 and extending therefrom to form a first terminal 241. The first terminal 241 and a second end 212 of the first conductor 21 form a second coupling region. The first coupling region and the second coupling region are respectively arranged on two opposite sides of the first conductor 21. The second branch 222 of the second conductor 22 is connected to the grounding plane 25.

A feeder cable 26 has a central wire 261 and an outer wire 262. The first conductor 21 receives the high-frequency signal from the central wire 261 and couples the energy of the signal to the second conductor 22. The signal passes the inductor member 23 on the second conductor 22 and reaches the grounding plane 25 via the second branch 222 of the second conductor 22. The outer wire 262 of the feeder cable 26 is directly connected to the grounding plane 25. Such a signal path forms a loop antenna structure and generates the standard frequency band of the low-frequency system of the digital TV. The inductor member 23 is a passive inductive element, and the serpentine path thereof can be used to adjust the inductance thereof. Thus, the antenna system has fine impedance matching.

As to the standard frequency band of the high-frequency system of the digital TV, the first terminal 241 of the extension conductor 24 couples the high-frequency signal from the central wire 261 to the second conductor 22. Then, the signal is interrupted by the choke effect of the inductor member 23 lest the signal of the high-frequency system continue to propagate and interfere with the low-frequency system.

The first conductor 21 has an L-like shape; the feed-in section, which the central wire 261 connects to, has a length of about 10 mm and a width of about 2 mm; the coupling section has a length of about 17 mm and a width of about 2 mm. The second conductor 22 has four sections; the first section, which is coupled to the first conductor 21, has a length of about 21 mm and a width of about 2 mm; the second section has a length of about 37 mm and a width of about 2 mm; the third section where the inductor member is arranged has a width of about 2 mm and a length of about 42 mm if the length of the inductor member 23 is subtracted from the entire length of the third section; the fourth section, which connects to the grounding plane 25, has a length of about 40 mm and a width of about 2 mm. The inductor member 23 has a length of about 24 mm. The extension conductor 24 is a straight-line structure having a length of about 22 mm and a width of about 2 mm. The grounding plane 25 is a rectangle having a length of about 10 mm and a width of about 8 mm. In this embodiment, the first conductor 21, second conductor 22, inductor member 23, extension conductor 24 and grounding plane 25 are all arranged on the same surface of the substrate. However, the first conductor 21 and the second conductor 22 may be respectively arranged on different surfaces of the substrate if the electric-coupling design of the two coupling regions requires it.

Refer to FIG. 3 a top view schematically showing an integrated multi-band antenna according to a second embodiment of the present invention. The second embodiment is basically similar to the first embodiment but different from the first embodiment in that a parasitic conductor 27 is extended from the second conductor 22 to near the grounding plane 25 in the second embodiment. The capacitive coupling effect of the parasitic conductor 27 and the grounding plane 25 generates capacitive impedance making the standard frequency band of the low-frequency system have fine impedance matching. In the second embodiment, the integrated multi-band antenna has two inductor members 23 both arranged near the first branch 221 of the second conductor 22, and the spacing of the serpentine paths of the inductor members 23 becomes smaller, and the length of the radiation conductors are also increased. Via adjusting the spacing and length of the serpentine path, the inductance can be changed, and the impedance matching of the antenna is modified.

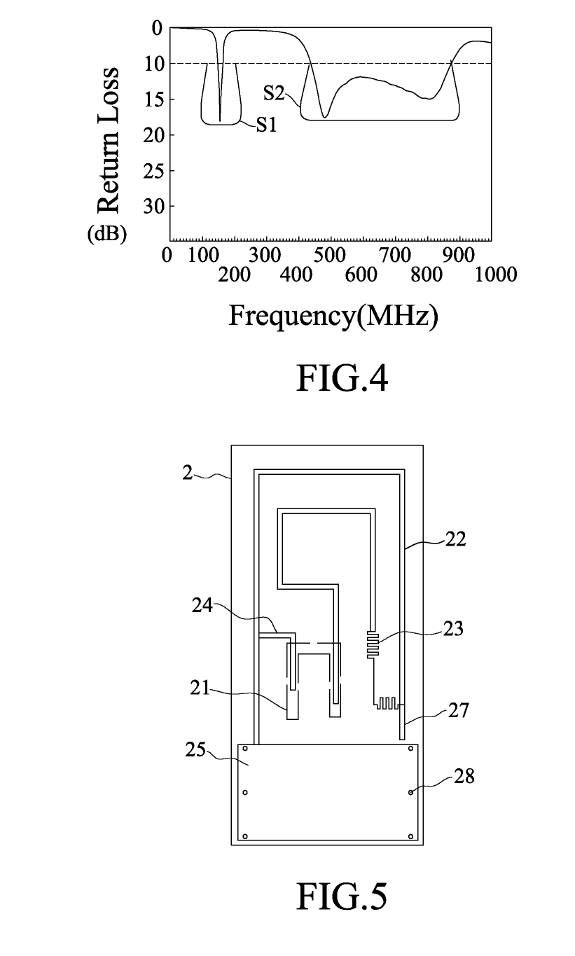

Refer to FIG. 4 a diagram showing the measurement result of the return loss of the antenna system according to the second embodiment of the present invention, wherein the horizontal axis represents frequency, and the vertical axis represents dB. When the operation frequency bands of the antenna system are defined by the return loss greater than 5 dB, there are an operation frequency band S1 ranging from 100 to 220 MHz, which covers the VHF system, and an operation frequency band S2 ranging from 400 to 880 MHz, which covers the UHF system. The measurement result proves that the antenna system of the present invention can achieve the required operation frequency bands.

Refer to FIG. 5 a top view schematically showing that an integrated multi-band antenna according to a third embodiment of the present invention is integrated with a substrate of a digital TV. The third embodiment is basically similar to the first embodiment but different from the first embodiment in that the first conductor 21 (indicated by the dotted lines) is arranged on the back side of a substrate 2, and that the second conductor 22, inductor member 23, extension conductor 24, grounding plane 25 and parasitic conductor 27 are arranged on the front side of the substrate 2. The present invention has two coupling regions. The feed-in signal is transmitted from the first conductor 21 to the second conductor 22 and the extension conductor 24 via a coupling way. Via a through-hole 28, the grounding signal is transmitted from the back side of the substrate 2 to the grounding plane 25 on the front side of the substrate 2, whereby the layout space of the antenna system is further reduced.

The present invention possesses utility, novelty and non-obviousness and meets the condition for a patent. Thus, the Inventor files the application for a patent. The embodiments described above are only to exemplify the present invention but not to limit the scope of the present invention. Any equivalent modification or variation according to the spirit of the present invention is to be also included within the scope of the present invention.

What is claimed is:

1. An integrated multi-band antenna comprising
a first conductor;
a second conductor, wherein said first conductor and a first branch of said second conductor form a first coupling region;
at least one inductor member arranged near said first branch of said second conductor;
an extension conductor arranged near a second branch of said second conductor and extending therefrom to form a terminal, wherein said terminal and said first conductor form a second coupling region, and wherein said first coupling region and said second coupling region are respectively arranged on two opposite sides of said first conductor; and
a grounding plane connected with said second branch of said second conductor.

2. The integrated multi-band antenna according to claim 1 further comprising a feeder cable including
a central wire connected to said first conductor; and
an outer wire connected to said grounding plane.

3. The integrated multi-band antenna according to claim 1, wherein said inductor member has a serpentine form.

4. The integrated multi-band antenna according to claim 1, wherein said inductor member is a passive inductive element.

5. The integrated multi-band antenna according to claim 1, wherein a parasitic conductor is extended from said second conductor.

6. The integrated multi-band antenna according to claim 5, wherein said parasitic conductor is arranged near said grounding plane.

7. The integrated multi-band antenna according to claim 1, wherein said first conductor, said second conductor, said inductor member, said extension conductor and said grounding plane are arranged on a substrate.

8. The integrated multi-band antenna according to claim 7, wherein said first conductor and said second conductor are arranged on a same surface of said substrate.

9. The integrated multi-band antenna according to claim 7, wherein said first conductor and said second conductor are respectively arranged on different surfaces of said substrate.
